(19) United States
(12) Patent Application Publication
(10) Pub. No.: US 2011/0190191 A1
(43) Pub. Date: Aug. 4, 2011

(54) Laundry Composition with Encapsulated Liquid Benefit Agent

(76) Inventors: Parmiladevie Marianne Balgobind-Narain, ATVlaardingen (NL); Sander Bas Kluit, Leiden (NL)

(21) Appl. No.: 12/223,724

(22) PCT Filed: Mar. 26, 2007
(86) PCT No.: PCT/EP2007/002715

§ 371 Date: Feb. 23, 2011

(30) Foreign Application Priority Data
Apr. 4, 2006 (EP) 06075799.4

(51) Int. Cl. C11D 17/00; B05D 7/00

(52) U.S. Cl. 510/349; 427/212

(57) ABSTRACT

A process for making aggregate granules comprising encapsulates or microcapsules of liquid benefit agent, preferably perfume, the process comprising the steps of: a) providing a powdered and/or granulated laundry composition comprising detergent particles selected from surfactants, fabric softeners and/or detergency builders; b) preparing a slurry comprising water, optional soluble materials, and encapsulates of liquid benefit agent; c) spraying the slurry prepared in step b) onto the laundry composition provided in step a) using a high rate of spray to create droplets larger than 70 micron in order to form aggregate granules of liquid benefit agent encapsulates anchored to detergent particles. Also, to particulate detergent compositions including the aggregate granules obtainable by the process and use of the compositions in laundry processes.

### TECHNICAL FIELD

This invention relates to a process to form granules that deliver an encapsulated liquid laundry benefit agent to laundry via a wash liquor, it also relates to the granules obtained by the process, to a laundry composition including the granules obtained, and to the use of such compositions.

### BACKGROUND TO THE INVENTION

It is well known to deliver to a wash liquor a liquid benefit agent protected in the form of an encapsulate or microcapsule. Encapsulated perfume is such a liquid benefit agent. Processes for incorporating perfume encapsulates into detergent formulations include: high shear granulation, low shear granulation, spray drying, spray-cooling, agglomeration, extrusion, spinning disk, and layering. Except for layering, these processes initially produce a particle or granule containing a high level of encapsulated benefit agent. The particle or granule is then introduced into the laundry composition. However, especially in the case where the benefit agent is to be delivered from a mechanically rupturable encapsulate, it has been found that the production and incorporation processes may lead to premature rupturing of the encapsulate and consequent loss of the benefit agent to the wash liquor. This is undesirable if the benefit agent is designed to be deposited onto the fabric in its encapsulated form; i.e. for later release of perfume during wear of a garment. (E.g. by mechanical stresses, sieve fractions, drying).

In order to prevent these undesirable losses of the benefit agent, alternative processes have been described. However, although an improvement, these have been found in practice still to give an unacceptably high level of loss and/or lead to lower production rates.

An example of such an alternative process is the layering process described in WO2005/059083. A detergent powder is fed to a drum and then sprayed with slurried perfume capsules at a dosage of 1 part slurry to 100 parts powder and a concentration of perfume encapsulates in the slurry of 50%. The spray rate is low and it takes 15 minutes to apply this much slurry. Because of the low rate of addition and the prolonged exposure to constant motion of the powder, the perfume is layered onto the surface of the powder. Unfortunately, these same process parameters can, in themselves, add to the likelihood of perfume loss. These losses being due to the long time that the early addition is impacted by the mixing process. Secondly, the thin layer of perfume encapsulates is then vulnerable to further losses by attrition in drying, packing and transportation and/or storage. Thus, by the time the powder is used the amount of perfume already lost from the encapsulates, and therefore released into the wash liquor in unprotected form, can be rather high.

WO2005/097962 describes a low shear granulation process, in the example a melamine capsule slurry was mixed to a sugar and zeolite blend. After drying, a free flowing powder was formed. A fluidised bed granulator is suggested as an alternative to the blender mixer used.

### DESCRIPTION OF THE INVENTION

According to the present invention there is provided a process for the incorporation of encapsulates of a liquid benefit agent into a protective granule, the composite protective granule being referred to hereafter as an aggregate granule. The preferred benefit agent is perfume and the preferred encapsulate is a microcapsule having a melamine formaldehyde outer shell. The process allows for ‘in-line’ or in-situ making of a granule during the blending of a detergent mix. The inventive process has the advantage of providing a simpler, faster and cheaper route for granule making.

The process consists of spraying large droplets of a dispersion containing encapsulates or microcapsules onto the detergent mix during blending. The water that is present in the dispersion is sufficiently absorbed by the surrounding powder to leave an aggregation of encapsulates or microcapsules adhered to the powder. For the same melamine encapsulated liquid benefit agent the granules formed by this process have been found to deliver similar benefits as found for granules made by fluid bed granulation, as suggested in WO2005/097962. Hence, a large majority of the encapsulates survive intact though the wash and are available to deposit onto fabric as encapsulates.

In order to increase storage stability even more, water-absorbing material, such as zeolite, can be added to the dispersion or slurry of the encapsulates.

The advantages of a granule, produced according to the process according to the invention, over a granule produced using a prior art process, for instance a layering process, is that the loss of benefit agent from the encapsulate during production is minimal and no extra drying step is needed. A drying step can cause perfume components to diffuse out of the microcapsule.

According to the invention, a process for making aggregate granules comprising encapsulates of liquid benefit agent anchored to detergent particles comprises the steps of:
a) providing a powdered and/or granulated laundry composition comprising detergent particles selected from surfactants, fabric softeners and/or detergency builders;
b) preparing a slurry comprising water, optional soluble materials and encapsulates of liquid benefit agent;
c) spraying the slurry prepared in step b) onto the powdered laundry composition provided in step a) using a high rate of spray to create droplets larger than 70 micron in order to form aggregate granules having the encapsulates of liquid benefit agent anchored to the detergent particles.

The preferred liquid benefit agent is perfume and the granules therefore preferably comprise encapsulates of perfume or perfume microcapsules, especially at levels more than 1 wt %. Preferably more than 3%, more preferably from 10% to 60% by weight of the granule consists of perfume microcapsules. The slurry produced in step b) may also comprise a coloured dye or pigment.

Advantageously the spraying step c) takes place in a low or medium shear mixer, that is one having a Froude number less than 1 and a ratio Fr to powder load of less than 0.01 per kg.

The laundry composition may be a product for cleaning and/or conditioning of laundry. Accordingly, the detergent particles may comprise softening materials. Thus, the detergent particles may be selected from surfactants, softening materials and/or detergency builders.

The invention also comprises particulate detergent compositions, containing a plurality of aggregate granules having encapsulates of liquid benefit agent anchored to detergent particles, obtainable by the process according to the invention, and characterised in that the percentage of the benefit agent associated with a sieve fraction of 1000 to 1400 μm of the composition is greater than 10% of the total of benefit agent associated with sieve fractions 0 to 1400 μm.

The benefit agent is preferably perfume. The invention also comprises the use of such particulate laundry detergent compositions in the cleaning and softening of fabrics in a washing process, for instance the use of such a laundry detergent in a laundry washing process at a concentration of 1 to 10 g of laundry detergent composition per litre of wash solution, preferably 6 to 8 g/l for European was conditions. Such a use desirably results in a breakage level in the wash solution of at most at most 20 wt % based on the total perfume content of the perfume encapsulates.

### The Process

The process of the invention is preferably carried out in a mechanical mixer, most preferably a low or moderate shear machine. Preferred mixers are drum mixers, concrete mixers, double cone mixers, and Forberg® ‘pedal mixers’.

Another type of low shear mixer that may be used is one of the gas fluidisation types. The slurry may be sprayed on from above and/or in the midst of the fluidised material.

The process may be carried out in either batch or continuous mode of operation, as desired.

One can use the Froude number to distinguish between low and moderate shear mixers and high shear mixers. The Froude number, Fr, is a dimensionless value that describes different flow regimes and is a ratio of inertial and gravitational forces. It can be calculated using the following formula:

Fr=r·ω²/g

where w is the rotational speed, r the radius and g the gravitational constant. When Fr=1, there is a critical flow, when Fr>1 the flow is supercritical (fast rapid flow), and when Fr<1, a subcritical flow (slow/tranquil flow) is present. When one translates this to a stream, then one can state that at critical flow celerity equals flow velocity. Any disturbance to the surface will remain stationary. In subcritical flow the flow is controlled from a downstream point and information is transmitted upstream. Supercritical flow is controlled upstream and disturbances are transmitted downstream.

Translating this to a powder mixer, one can state that when Fr<1, the level of shear decreases when reaching Fr=0. When Fr>1, the level of shear increases. This can also be seen for the given examples: the drum mixer has a much lower Fr (and shear) than a ploughshare.

Not only do dimensions of the machinery and rotational speeds influence the level of stress or shear in a mixer, but the batch size also plays an important role. This influence can be predicted by considering the ratio of Froude number to batch size. Thus whilst Froude numbers below 1 are generally desirable the ratio of Froude number to batch size (kg) should preferably be less than 0.01

The process consists of spraying large droplets of slurry onto a powder bed. Ninety percent of these droplets need to have a size in a range of 50 μm to 1000 μm, preferably 70 μm to 700 μm and most preferably from 100 μm to 500 μm, as measured by laser diffraction. The droplets may be sprayed using either a single phase, or a two phase, nozzle. For the two-phase nozzle, one phase is a pressurised gas and the second phase the slurry.

Once the droplets collide with the powder bed, the excess liquid in the slurry is absorbed by the lower relative humidity detergent powder and the surrounding air, leaving a structured droplet behind. The droplet continues to dry and forms an aggregate granule of microcapsules anchored onto the detergent particle(s). Because the aggregate granule is over 70 micron in diameter and because it is protected by being anchored onto the detergent particle, it is believed that the attrition of the microcapsules is much reduced. Nevertheless, the microcapsules may still be released again and dispersed once the aggregate granule is dissolved or dispersed to make a washing or conditioning liquor.

### The Slurry

The process consists of spraying large droplets of slurry onto a powder bed. Typically, the slurry comprises from 10 to 80 wt % of encapsulated liquid benefit agent (microcapsules) and from 20 to 90 wt % water: Optionally, other ingredients may be included in the slurry, for example from 0 to 40 wt % polymeric material, to impart deposition or other beneficial properties.

### The Encapsulates or Microcapsules

The preferred liquid benefit agent is perfume. The perfume is encapsulated to form a microcapsule, which is designed to prevent the perfume being released to a wash liquor. The microcapsules may be of the type that comprises a core of carrier material impregnated with a perfume, the impregnated core being coated with a friable coating.

One preferred class of microcapsule comprises those generally of the kind described in U.S. Pat. No. 5,066,419, these comprise a core having from about 5% to about 50% by weight of perfume dispersed in from about 95% to about 50% by weight of a carrier material. This carrier material is a non-polymeric solid fatty alcohol or fatty ester carrier material, or mixtures thereof. The esters or alcohols have a molecular weight of from about 100 to about 500 and a melting point from about 37° C. to about 80° C. The alcohols or esters are substantially water-insoluble. The cores comprising the perfume and the carrier material are coated with a substantially water-insoluble coating on their outer surfaces. Although the microcapsules recited in U.S. Pat. No. 5,066,419 are indicated as having an average particle size less than about 350 microns, preferably less than 150 microns, for the avoidance of doubt, in the context of the present invention, these particles preferably have a d_{4.3} average particle size of from 0.01 to 300 microns more preferably from 1 to 100 microns. Similar microcapsules are disclosed in U.S. Pat. No. 5,154,842 and these are also suitable.

The microcapsules as described in U.S. Pat. No. 5,066,419 have a friable coating which is preferably an aminoplast polymer. Most preferably, this is the reaction product of an amine selected from urea and melamine, or mixtures thereof, and an aldehyde selected from formaldehyde, acetaldehyde, glutaraldehyde or mixtures thereof. Preferably, the coating is from 1 to 30 wt % of the particles. The carrier material preferably comprises an alcohol selected from the C₁₄-C₁₈ alcohols or an ester comprising at least 18 carbon atoms. However, perfume microcapsules of other kinds are also suitable for use in the present invention. Ways of making such other microencapsulates of perfume include precipitation and deposition of polymers at the interface such as in coacervates, as disclosed in GB-A-751 600, U.S. Pat. No. 3,341,466 and EP-A-385 534, as well as other'polymerisation routes such as interfacial condensation, as described in U.S. Pat. No. 3,577,515, US-A-2003/0125222, U.S. Pat. No. 6,020,066 and WO-A-03/101606.

### Other Components of the Slurry

Other materials, both soluble and insoluble may be included in the slurry in addition to the microcapsules. For example salts and/or other inorganic material such as zeolite may also be included. Once the water of the slurry is absorbed by the surrounding powder, the salt(s) and/or other materials having the capacity to absorb liquid, will form a granule also containing the functional ingredient.

Suitable materials for inclusion in the slurry may provide the functions of binder material, agglomerating aid, stabilising aid and deposition aid. Examples of such materials are water soluble polymers such as polyvinyl pyrrolidone, water soluble cellulose; polyvinyl alcohol; ethylene maleic anhydride copolymer; methyl vinyl ether maleic anhydride copolymer; polyethylene oxides; water soluble polyamide or polyester; copolymers or homopolymers of acrylic acid such as polyacrylic acid, polystyrene acrylic acid copolymers or mixtures of two or more of these. Examples of suitable water-soluble hydroxyalkyl and carboxyalkyl celluloses include hydroxyethyl and carboxymethyl cellulose, hydroxymethyl and carboxymethyl cellulose, hydroxypropyl carboxymethyl cellulose, hydroxypropyl methyl carboxyethyl cellulose, hydroxypropyl carboxypropyl cellulose, hydroxybutyl carboxymethyl cellulose and the like. Also useful are alkali metal salts of these carboxy alkyl celluloses, particularly and preferably the sodium and potassium derivatives.

Examples of suitable water-soluble natural and modified natural polymers are starch, gums and gelatine. Suitable hydrolysed gums include gum Arabic, larch, tragacanth, locust bean, guar, alginates, carrageenans, and cellulose gums.

Examples of suitable water-insoluble solid inert materials are magnesium silicate, calcium silicate, barium titanium silicate, magnesium hydroxide, barium sulphate, silica, aluminosilicates such as zeolites and minerals such as clay or calcium carbonate, sodium citrate, sodium phosphate, sodium sulphate, sodium acetate and magnesium sulphate, and mixtures thereof.

Preferably, the slurry contains up to 50 wt %, preferably from 0.01% up to 40 wt % of such materials in addition to the microcapsules.

### EXAMPLES

In the examples, the liquid microencapsulated benefit agent chosen is perfume in a melamine formaldehyde shell. The percentage leakage of perfume is measured against a reference composition with the same amount of perfume added directly to a wash bath. The test composition and the reference are each added to a representative wash bath at ca. 40° C. The perfume released to the wash bath in each case is analysed by sampling of the headspace and the amount of perfume released from the microcapsules is thereby compared to the reference unprotected perfume. This is done by SPME (Solid phase Micro Extraction) gas chromatography/mass spectrometry methods known to the person skilled in the art. If no perfume is released to the wash, this is 0% leakage. On the other hand, if the same amount is released as would have been the case for the unprotected perfume this is 100% leakage.

### Examples 1 to 5

A drum mixer is fed with a zeolite built heavy duty detergent powder onto which slurry containing 50 wt % perfume capsules in water as hereinbefore described is sprayed for 2 minutes using a SUN23 flat spray nozzle ex Spraying System Co. The droplet size of the spray is regulated by the flow of slurry and the flow of atomising air. Effectiveness of the process is determined by measuring perfume that has escaped from broken capsules. This example shows the effect of a very fine spray on the mechanical stability of the capsules. The process parameters and results are detailed in table 1. Examples 1* and 3* are comparative and examples 2, 4 and 5 are according to the invention.

TABLE 1

| | Example | Example | Example | Example | Example |
|---|---|---|---|---|---|
| | 1* | 2 | 3* | 4 | 5 |
| Mixer type | 150 litre | 150 litre | 50 litre | 50 litre | Concrete |
| | concrete | concrete | plough | plough | mixer |
| | mixer | mixer | share | share | |
| Cylinder | 1.5 | 1.5 | 0.4 | 0.4 | 0.5 |
| diameter | | | | | |
| Number of | 1 | 1 | 1 | 1 | 1 |
| cylinders | | | | | |
| rpm | 20 | 20 | 191 | 191 | 40 |
| Batch (kg) | 50 | 50 | 15 | 15 | 10 |
| Mixing | 2.5 | 2.5 | 2.5 | 2.5 | 2.5 |
| time | | | | | |
| (mins) | | | | | |
| Spray-on | 100 | 100 | 50 | 50 | |
| rate | | | | | |
| gr./min | | | | | |
| Air | 3.0 | 1.0 | 3.0 | 0.6 | |
| pressure | | | | | |
| (bar) | | | | | |
| Droplet | <50 | >100 | <50 | >100 | >100 |
| size Dv90 | | | | | |
| (μm) | | | | | |
| Leakage | ~30% | <10% | ~60% | ~30% | <10% |
| Fr | 0.19 | 0.19 | 0.33 | 0.33 | 0.03 |
| Froude to | 0.00377 | 0.00377 | 0.02175 | 0.02175 | 0.00279 |
| powder | | | | | |
| volume | | | | | |

### Examples 6 and 7

### Particle Size Distribution and the Location of the Encapsulates

To demonstrate that the product according to the inventive process is different from the prior art layered product an experiment was devised. Theoretically, a layering process provides a substantially uniform layer of perfume encapsulates on detergent particles irrespective of their size. This results in a disproportionate amount of the total perfume encapsulates being present on smaller particles (due to them having a higher surface area to weight ratio than the larger particles). On the other hand, the inventive process ensures that the benefit components (in this case perfume capsules) are predominantly present aggregated with the larger particles. This is confirmed when the total perfume level of the sieve fractions of the detergent mix are analysed.

The data in table 2 shows that Example 7 (which is the analysis of example 2 according to the invention) has >50% of the perfume encapsulates in the powder particle fraction >500 μm. Moreover, >10% of the total perfume analysed to be in the fractions up to 1400 μm is found associated with particles >1000 μm. This analysis can be seen to contrast markedly with the distribution of comparative example 6*, which is the sieve fractions of the product from example 2*. The skilled worker is able without difficulty to devise a suitable method to extract the perfume from the sieve fraction and to measure it.

Furthermore, as the critical aspect is a percentage this should be independent of the exact method used for the perfume analysis. For this experiment, we analysed for perfume by HPLC techniques after releasing the perfume by an intensive mechanical grinding process.

TABLE 2

| | Example 6* (prior | | Example 7 | |
|---|---|---|---|---|
| | art layering) | | (invention) | |
| Sieve | | Perfume | | Perfume |
| Fraction | | distribution | | distribution |
| [μm] | [%] | [% of 0-1400] | [%] | [% of 0-1400] |
| >1400 | 2.9 | — | 1.6 | — |
| 1000 < 1400 | 1.4 | 0.5 | 5.6 | 13.8 |
| 710 < 1000 | 15.1 | 9.2 | 12.4 | 24.6 |
| 500 < 710 | 18.4 | 16.0 | 17.4 | 25.1 |
| 355 < 500 | 19.7 | 17.1 | 20.5 | 15.3 |
| 0 < 355 | 42.6 | 57.2 | 42.5 | 21.2 |
| SUM | 100 | 100 | 100 | 100 |

1. A process for making aggregate granules comprising encapsulates of liquid benefit agent anchored to detergent particles, the process comprising the steps of:
a) providing a powdered and/or granulated laundry composition comprising detergent particles selected from surfactants, fabric softeners and/or detergency builders;
b) preparing a slurry comprising water, optional soluble materials, and encapsulates of liquid benefit agent;
c) spraying the slurry prepared in step b) onto the laundry composition provided in step a) using a high rate of spray to create droplets larger than 70 micron in order to form aggregate granules having encapsulates of liquid benefit agent anchored to detergent particles.

2. A process as claimed in claim 1 in which the liquid benefit agent is perfume and the aggregate granules formed in step c) comprise perfume encapsulates or microcapsules at levels of more than 1 wt %, preferably more than 3%, more preferably from 10% to 60% by weight of the granule.

3. A process as claimed in claim 1 in which the slurry produced in step b) also comprises a coloured dye or pigment.

4. A process according to claim 1 in which the spraying step c) takes place in a low or medium shear mixer, having a Froude number (Fr) less than 1 and a ratio Fr to powder load of less than 0.01 per kg.

5. A particulate laundry detergent composition including a plurality of aggregate granules encapsulates of liquid benefit agent anchored to detergent particles, obtainable by the process as claimed in claim 1, and characterised in that the percentage of the benefit agent associated with the sieve fraction of 1000 to 1400 μm is greater than 10% of the total of benefit agent associated with sieve fractions 0 to 1400 μm.

6. A laundry detergent composition according to claim 5 wherein the benefit agent is perfume.

7. A laundry detergent composition according to claim 5 comprising a zeolite builder.

8. A laundry detergent composition according to claim 6 in which more than 50% of the encapsulated perfume is contained in aggregate granules than will not pass through a 500 μm sieve.

9. Use of a laundry detergent composition as claimed in claim 6 in a laundry washing process at a concentration of 1 to 10 g/l of wash solution, preferably 6 to 8 g/1.

10. Use as claimed in claim 9 in which the perfume encapsulates comprising the aggregate granules have a breakage level in the wash solution of at most 20 wt % based on the total perfume content of the perfume encapsulates.
